(19) United States
(12) Patent Application Publication
(10) Pub. No.: US 2013/0062012 A1
(43) Pub. Date: Mar. 14, 2013

(54) METHOD FOR MAKING AN ARM FOR A HINGED STRUCTURE SUCH AS A ROCKER ARM FOR AN AIRCRAFT LANDING-GEAR STRUCTURE

(71) Applicants: Richard Masson, Les Loges en Josas (FR); Patrick Dunleavy, Palaiseau (FR)

(72) Inventors: Richard Masson, Les Loges en Josas (FR); Patrick Dunleavy, Palaiseau (FR)

(73) Assignee: MESSIER-BUGATTI-DOWTY, Velizy Villacoublay (FR)

(21) Appl. No.: 13/574,327

(22) PCT Filed: Jan. 19, 2011
(86) PCT No.: PCT/EP2011/000200

§ 371 Date: Oct. 22, 2012

(30) Foreign Application Priority Data
Jan. 22, 2010 (FR) 1050416

(51) Int. Cl. B32B 37/14

(52) U.S. Cl. 156/305

(57) ABSTRACT

The invention relates to a method for making an arm for a hinged structure such as an aircraft landing gear structure, this arm comprising a main body (30; 130; 230) extending in a longitudinal direction (AP; BP; CP), and including an interface (13; 113; 213) such as a yoke radially protruding from the main body, this method including the steps of:
making an insert (11; 211) including a base (12; 212) carrying the interface;
making a mandrel (10; 110) integrating the base of the insert so that a portion of the external surface of this mandrel is delimited by a portion of the external face (17; 217) of the base of the insert;
applying one or more layers of reinforcing fibers (31; 131; 231) around the mandrel and over all its length, so that each layer has the interface (13; 113; 213) passing through it without covering the interface;
injecting resin into the layer or layers of reinforcing fibers (31; 131; 231) and at the level of the area of contact (32) of these layers (31) with the external face (17; 217) of the base; and
polymerizing the resin to bind rigidly the layers of reinforcing fibers and the base of the insert.

### BACKGROUND OF THE INVENTION

The present invention concerns a method for making an arm for a hinged structure such as rocker arm for an aircraft landing gear structure.

A landing gear rocker arm takes the form for example of a link having at each of its ends an interface in the form of a bearing and at least one other, so-called intermediate, interface situated between its ends and taking the form of a yoke.

In FIG. 1 there is shown diagrammatically landing gear equipped with such a rocker arm. The landing gear 1 comprises a main leg 2 at the lower end of which is mounted a front end of a rocker arm 4 comprising a bearing 3 so that this rocker arm is able to pivot relative to the leg about a horizontal transverse axis.

Two wheels 5 of the landing gear are carried by a transverse shaft or axle mounted at the rear end of the rocker arm, i.e. at the level of its rear bearing 6, these wheels thus being mounted on either side of the rocker arm.

In a complementary way, a shock absorber 7 is disposed between the rocker arm and the leg of the landing gear, having a lower end fastened to the intermediate yoke 8 of the rocker arm 4 and an upper end fastened to an upper part of the leg. Each end of the shock absorber 7 is able to pivot about a horizontal axis relative to the part to which it is fastened.

As emerges from FIG. 1, during landing, the reaction of the ground on the wheels 5 tends to cause the rear end of the rocker arm to rise, against the forces exerted by the shock absorber 7 on the intermediate yoke 8, which enables damping of the landing impact.

Accordingly, during landing, and likewise when the aircraft is taxiing or stationary on the ground, the rocker arm is mainly subjected to bending and twisting forces exerted more or less vertically by the leg at the level of its front end, by the wheels at the level of its rear end, and by the spring at the level of the intermediate yoke.

These forces are of the same order of magnitude as the mass of the aircraft, with the result that the rocker arm must have a high mechanical strength, in particular at the level of its interfaces, i.e. at the level of its front and rear bearings and at the level of its intermediate yoke.

In FIG. 2, such a rocker arm 4 has been represented on its own. It comprises a main body 9 extending in a main direction P and the two ends whereof include so-called front and rear bearings 3 and 6.

As can be seen in FIG. 2, the main body has a substantially constant cross section along the axis P and carries the intermediate yoke (8), which projects radially from this main body.

Given the high mechanical strength expected of such a rocker arm, and its relatively complex shape, it is typically made from machined high-strength steel.

Achieving a significant saving in weight at the level of this part, by making it from a composite material, proves to be a problem given the complexity of its general shape.

In one known solution, such a composite material rocker arm is obtained by first making a simple composite material connecting rod the main body whereof has a constant substantially circular section. A collar carrying a double yoke is then fitted around this connecting rod, this collar being clamped around the main body so as to be rigidly fastened thereto.

This solution continues to have severe constraints in terms of fabrication costs and weight since it leads to the rocker arm being made in the form of a plurality of composite material parts that have to be assembled together at the same time as providing high mechanical strength.

### OBJECT OF THE INVENTION

The object of the invention is to propose a method for making an arm for a composite material hinged structure integrating at least one interface situated between its ends and having a low fabrication cost.

### BRIEF DESCRIPTION OF THE INVENTION

To this end, the invention provides a method for making an arm for a hinged structure such as an aircraft landing gear structure, this arm comprising a main body extending in a longitudinal direction, and including an interface such as a yoke radially protruding from the main body, this method including the steps of:
making an insert including a base carrying the interface;
making a mandrel integrating the base of the insert so that a portion of the external surface of this mandrel is delimited by a portion of the external face of the base of the insert;
applying one or more layers of reinforcing fibers around the mandrel and over all its length, so that each layer has the interface passing through it without covering the interface;
injecting resin into the layer or layers of reinforcing fibers and at the level of the area of contact of these layers with the external face of the base; and
polymerizing the resin to bind rigidly the layers of reinforcing fibers and the base of the insert.

The fabrication method of the invention pays particular attention to obtaining optimum cohesion between the layers and the insert. Moreover, in contrast to the solution cited above, the yoke and the base forming the insert are made in one piece. The arm obtained in this way is particularly strong and light and so addresses at low cost the requirements of a hinged structure such as an aircraft landing gear structure.

The invention also provides a method as defined above wherein the base has a generally tubular shape, the mandrel is formed in line with the external face of the base with at least one sleeve in which a sealed junction is made between these two elements.

The invention further concerns a method as defined above wherein the tubular base has a longitudinal section of beveled shape adapted to distribute the forces on the internal walls of the main body.

### BRIEF DESCRIPTION OF THE DRAWINGS

Other features and advantages of the invention will become apparent on reading the following description of particular embodiments of the invention with reference to the appended figures, in which:

FIG. 1 is a lateral view of the lower part of aircraft landing gear including a prior art rocker arm;

FIG. 2 is a perspective view of a prior art rocker arm;

FIG. 3 is a partial view in perspective and in section showing a central portion of the rocker arm of the invention;

FIG. 4 is a lateral view in section of the insert;

FIG. 5 is a partial lateral view in section of the mandrel;

FIG. 6 is a perspective view of the braiding operation of the method of the invention;

FIG. 7 is a partial lateral view in section of the rocker arm of the invention;

FIG. 8 is a perspective view of the central portion of the rocker arm of the invention;

FIG. 9 is a partial perspective view showing a portion of the rocker arm conforming to a second embodiment of the invention;

FIG. 10 is a partial view in section showing a portion of the rocker arm conforming to a third embodiment of the invention.

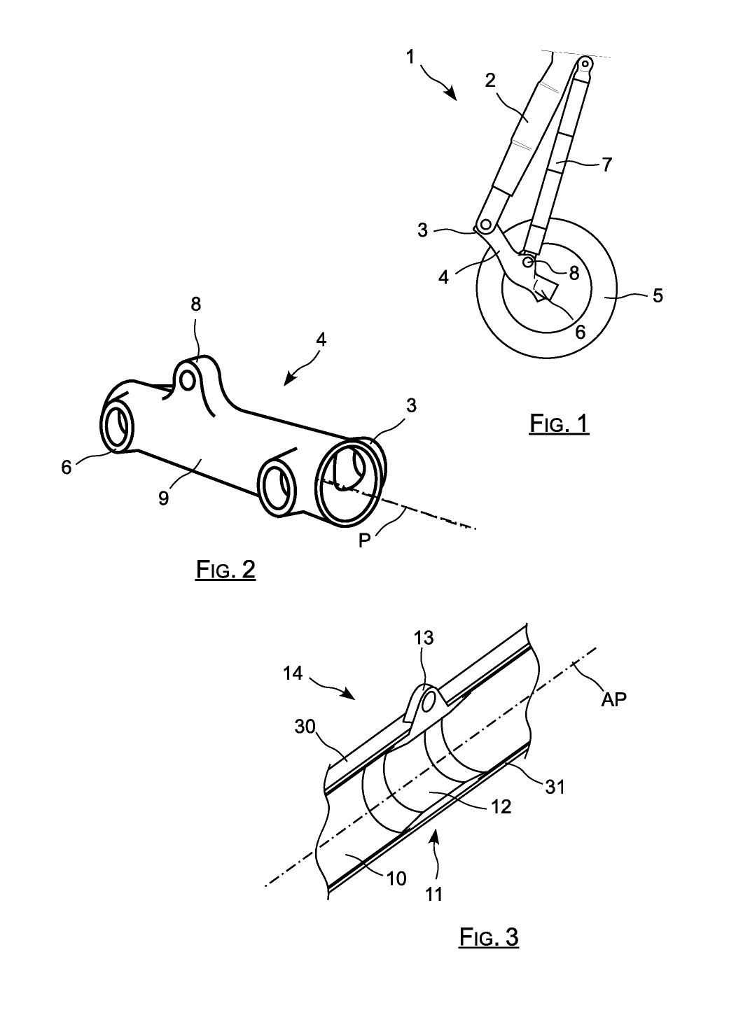

### DETAILED DESCRIPTION OF THE INVENTION

As can be seen in FIG. 3, the basic idea of the invention is to integrate with a mandrel 10 an insert 11 comprising a base 12 carrying an interface 13 such as a yoke, to cover this mandrel with a plurality of layers of braided reinforcing fibers 31, to inject resin into these layers and polymerize it in order to obtain optimum cohesion between the layers and the insert.

The base 12 of the insert is thus an element of the mandrel 10 forming a part of the support onto which layers of reinforcing fibers 31 are applied directly so that the resin efficaciously fastens these layers to the base to assure optimum transfer of forces between these layers and the insert.

Moreover, the base 12 thus has an external shape that is rigorously complementary to the internal shape delimited by the layers of reinforcing fibers 26, with the result that it is nested in the internal space delimited by the layers of reinforcing fibers constituting the main body of the rocker arm.

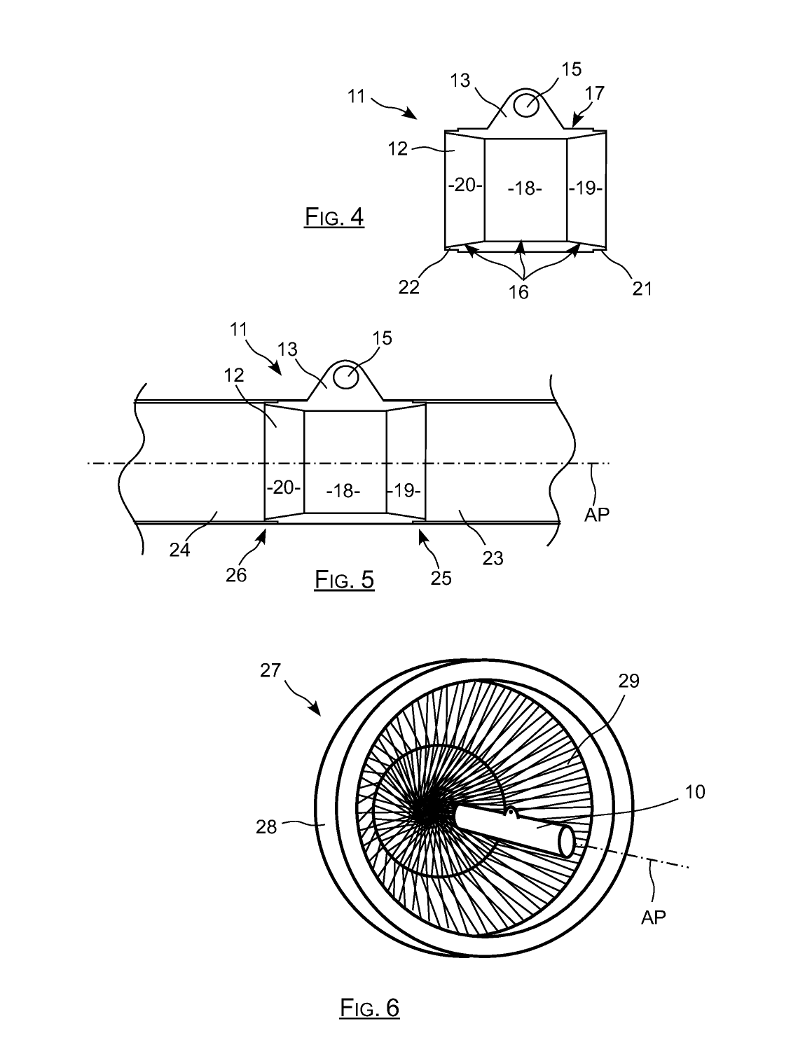

As shown in FIG. 4, the insert 11 comprises the base 12 carrying the yoke 13, the latter comprising a bore 15 enabling fixing of the rocker arm to another element, not shown, for example a shock absorber of the landing gear.

The base 12 has the shape of a body of revolution about an axis AP: it is generally tubular, being delimited by an internal face 16 and by an external face 17, both the shape of a body of revolution. The internal face 16 comprises a cylindrical central area 18 extended on either side by frustoconical areas 19, 20 forming flares. For its part the external face 17 is essentially cylindrical and includes at each of its ends a shoulder 21, 22.

Thanks to the flared portions 19, 20 of the internal face, the tubular base 12 has a thickness that decreases toward each of its ends, with the result that as seen in longitudinal section the ends of this base are beveled. This reduction of thickness confers on the base greater flexibility at the level of its ends than in its thicker central region. This beveled shape enables continuous variation of flexibility limiting any step increase in stiffness.

The insert 11 may be made by thermocompaction: it is obtained from composite material including short non-woven fibers amalgamated in any direction and compacted and then embedded in a resin at high temperature. The whole is placed in a mould enabling the required shape of the insert to be obtained. The raw part obtained in this way may be machined so that its geometry conforms to a predefined dimensions and tolerances.

The machining of the yoke 13 may be effected before mounting the mandrel 10, or afterwards. This yoke defines fixing means passing through the peripheral braided composite material layers; it may be a single yoke, as shown, a double yoke or any other form of fixing means.

The insert 11 may also be fabricated using long fibers by winding or by draping, i.e. by applying woven layers pre-impregnated with resin or based on injected Cartesian braiding. Whatever fabrication method is chosen, the insert is then pre-polymerized.

Generally speaking, if the yoke 13 is designed to be subjected to relatively low forces, the insert 11 may be made by thermocompaction. On the other hand, if this yoke must be subjected to high forces, the insert 11 is advantageously made by winding, draping or Cartesian braiding.

Once finalized, the insert is pre-polymerized, conferring on it sufficient stiffness to constitute a part of the mandrel 10 onto which one or more layers 31 of graded reinforcing fibers can be applied.

To respective ends of the insert 11 there are then fixed two cylindrical sleeves 23 and 24 for forming the mandrel 10 extending longitudinally along an axis AP.

Each sleeve 23, 24 is made of composite material, for example using portions of woven material pre-impregnated with resin applied to a cylindrical support. This support is then removed, after at least partial solidification of the pre-impregnating resin, so as to constitute sleeves having sufficient stiffness to confer on them their own shape.

Each sleeve is then pre-polymerized, conferring on them sufficient stiffness to define a part of the mandrel 10 to which one or more layers 31 of braided reinforcing fibers can be applied.

Assembling the sleeves 23, 24 with the insert 11 to form the mandrel 10 is carried out in sealed manner at the level of the junctions 25, 26 between the base 12 of the insert and each sleeve 23, 24 to prevent introduction of resin into the mandrel 10 during a subsequent resin injection operation.

More particularly, one end of the cylindrical sleeve 23 is nested around the corresponding end of the generally tubular base 12, being engaged around the shoulder 21, at the level of a joining area 25. The same applies to the sleeve 24 the end of which is engaged around the other shoulder 22 of the base 12, at the level of another junction 26.

In order to improve the seal at the level of each junction 25, 26, glue or other appropriate material may be used.

Moreover, the depth of each shoulder 21, 22 corresponds to the thickness of each sleeve 23, 24, so that the external face of the mandrel produced in this way is generally continuous and smooth, in particular at the level of each junction 25, 26.

In other words, the outside diameter of the base 12 at the level of each shoulder corresponds to the inside diameter of each sleeve and the nominal diameter of the external face 17 of the base, between its shoulders, corresponds to the outside diameter of the sleeves 23, 24.

Once assembled, the mandrel 10 has sufficient stiffness to constitute a support onto which one or more layers 31 of braided reinforcing fibers may be applied.

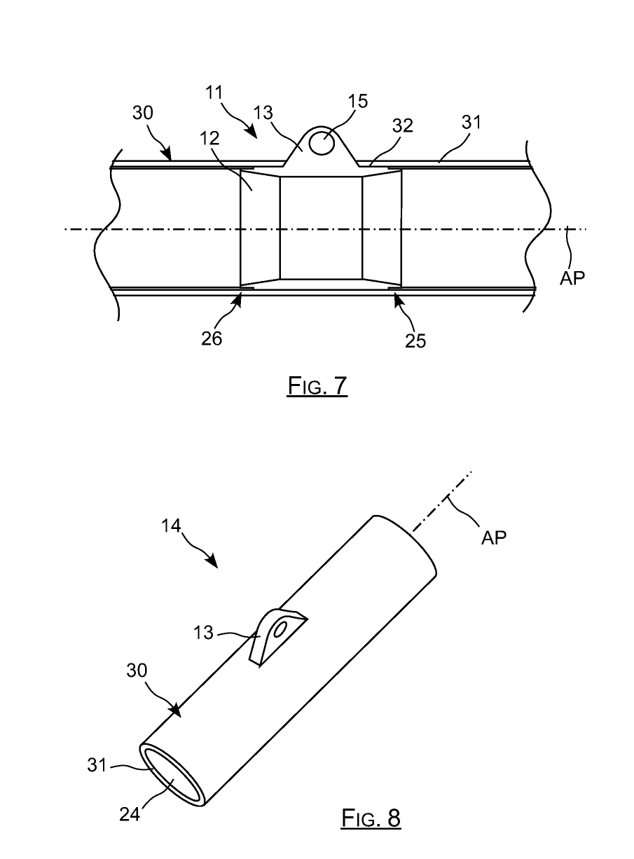

As can be seen in FIG. 6, the mandrel 10 is then installed in a braiding machine 27 that essentially includes a support ring 28 on the rear face of which is mounted a series of spools of fibers such as carbon fiber, carried by supports mobile in rotation. These fibers 29 come together in a region that is situated substantially on the axis P whilst being offset along that axis relative to the plane of the support ring 28.

The support ring 28 is centered on the axis P, lying in a plane normal to that axis. When the braiding cycle is started, the mandrel 10 is moved along the axis AP relative to the support ring 28, which brings about the braiding of a sock of fibers on the external face of the mandrel 10.

In operation, the speed of the mandrel 10 relative to the ring 28 is adjusted so that the braided fibers 29 around it are oriented with a predetermined inclination relative to the axis AP.

A plurality of such passes are carried out to constitute a plurality of layers 31 of braided fibers around the mandrel 10, each layer having a substantially constant thickness.

Covering the yoke is avoided during this operation. The yoke is machined to its final shape at this stage of the fabrication process or afterwards, depending on the embodiment concerned.

If the yoke has not yet been machined, its intermediate shape could be of frustoconical or elliptical type, extending radially toward the exterior of the rocker arm so that none of the fibers situated at the level of the yoke can be deposited thereon but, to the contrary, these fibers slide along the frustoconical or elliptical wall to be disposed on the mandrel 10 at its base.

In the same manner, if the yoke has already been formed, the braided reinforcing fibers are disposed on either side of the yoke so that it is not covered.

Alternatively, and whatever the state of the yoke 13, it may be covered with protection of frustoconical or elliptical type for the same reasons.

Once the various braided layers 31 have been applied, the raw part that the mandrel 10 then includes surrounded by the various layers 31 of fibers is placed in a mould.

A resin is then injected to impregnate completely the various layers 31 of braided fibers until it reaches the external face of the mandrel 10. To this end, the sealed junctions 25, 26 between the base 12 and the sleeves 23, 24 prevent intrusion of resin into the mandrel 10 during injection.

The resin is polymerized by heating: after injection of the resin, the mould is controlled to bring about a curing cycle which hardens the resin in the layers 31 of composite material around the mandrel 10.

Once polymerized, this resin provides the cohesion between the mandrel 10 and these layers 31, in particular at the level of the area of contact 32 where the layers 31 are in contact with the external face 17 of the insert 11 in order to obtain optimum transmission of forces applied to the insert to the peripheral layers 31 of braided fibers.

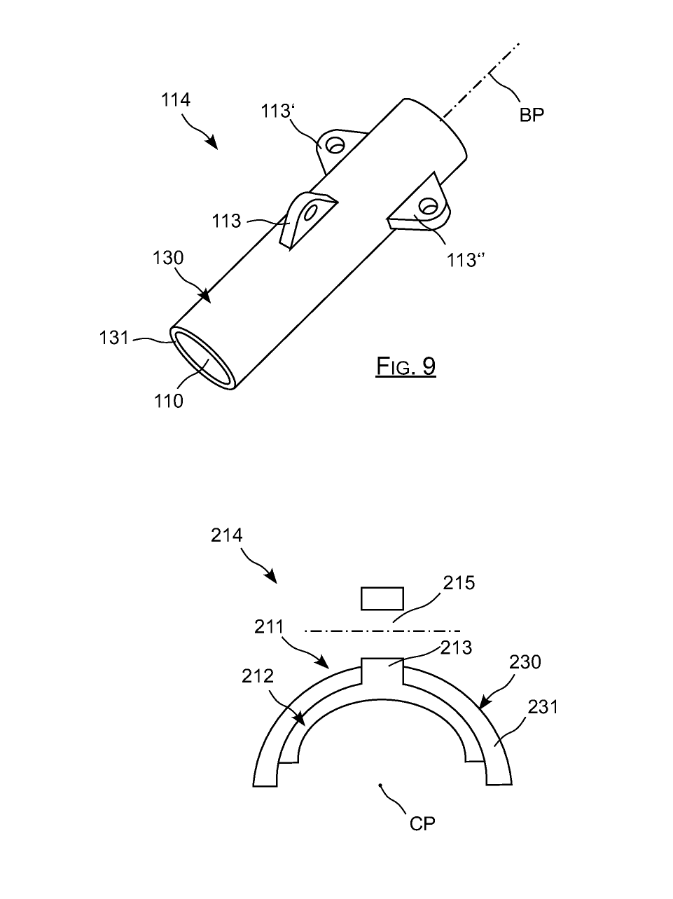

As can be seen in FIGS. 7 and 8, the central portion of the rocker arm made in accordance with the invention thus includes the mandrel 10 composed of the insert 11 and the sleeves 23 and 24, as well as a set of layers of reinforcing fibers around this mandrel 10 embedded in the hardened resin.

The mandrel on the one hand imparts to the assembly its general shape by constituting a support onto which the layers of reinforcing fibers are applied to form the main body 30 and, thanks to its insert 11 carrying the yoke 13, it enables an optimum connection to be obtained between the yoke 13 and this main body.

As will have been understood, the figures show only the central portion of the rocker arm of the invention, i.e. the portion comprising the yoke 13. The ends of this rocker arm each comprise an interface that is not shown, for example taking the form of bearings that may be obtained by drilling each end of the rocker arm transversely.

The method that may be applied to making rocker arms of the type represented in FIGS. 3 to 8 applies equally to other types of rocker arms, such as that from FIG. 9, for example, which comprises three yokes 113, 113′, 113″ instead of only one.

As can be seen in FIG. 9, the yokes 113′, 113″ are disposed in diametrically opposite positions relative to the axis BP and the yoke 113 is spaced longitudinally along that same axis and at an angle of 90° relative to the yokes 113′ and 113″. In such a configuration, the yokes 113, 113′ and 113″ may be either connected to a single insert or divided between two inserts. In the latter case, the yokes 113′ and 113″ are then integrated into the same insert and the yoke 113 into a second insert placed in a limitrophic manner with respect to the first insert along the longitudinal axis BP.

Depending on what is required, the sleeve could then integrate one insert or more, each insert then being able to carry one or more yokes spaced longitudinally along the axis BP and/or circumferentially around that same axis.

In other embodiments, as shown in FIG. 10, the rocker arm may integrate an insert of open section, such as a half-tube carrying the yoke 213. The assembly of the insert 211 and the layer 231 of braided reinforcing fibers may be consolidated by a mechanical type connection such as rivets, nuts and bolts, etc. These latter elements are in this case mounted after polymerization of the resin, by drilling and then, depending on the embodiment, by screwing to enhance further the cohesion between the insert and the carbon fiber main body.

Whichever embodiment is chosen, the mandrel is advantageously made from a composite material including a resin of the same type as that injected into the external layers of braided reinforcing fibers to obtain the best cohesion with those external layers. Moreover, the inserts advantageously include fibers of the same type as the layers of braided external reinforcing fibers so as to have a high mechanical strength.

This being so, the mandrel may also be made from another material, and this applies to the sleeve as well as to the reinforcing inserts, provided that these elements have the required characteristics in terms of their mechanical strength and the possibility of ensuring optimum cohesion between them and the layers of braided reinforcing fibers.

1. A method for making an arm for a hinged structure such as an aircraft landing gear structure, this arm comprising a main body (30; 130; 230) extending in a longitudinal direction (AP; BP; CP), and including an interface (13; 113; 213) such as a yoke radially protruding from the main body, this method including the steps of:
making an insert (11; 211) including a base (12; 212) carrying the interface;
making a mandrel (10; 110) integrating the base of the insert so that a portion of the external surface of this mandrel is delimited by a portion of the external face (17; 217) of the base of the insert;
applying one or more layers of reinforcing fibers (31; 131; 231) around the mandrel and over all its length, so that each layer has the interface (13; 113; 213) passing through it without covering the interface;
injecting resin into the layer or layers of reinforcing fibers (31; 131; 231) and at the level of the area of contact (32) of these layers (31) with the external face (17; 217) of the base; and
polymerizing the resin to bind rigidly the layers of reinforcing fibers and the base of the insert.

2. The method claimed in claim 1, wherein the base (12; 212) has a generally tubular shape.

3. The method claimed in claim 1, wherein the mandrel (10; 110) is formed in line with the external face of the base (17; 217) with at least one sleeve (23; 24).

4. The method claimed in claim 3, wherein a sealed junction (25, 26) is made between the base (12; 212) and each sleeve (23, 24).

5. The method claimed in claim 4, wherein the tubular base (12; 212) has a longitudinal section of beveled shape (19, 20) adapted to distribute the forces on the internal walls of the main body (30; 130; 230).

6. The method claimed in claim 2, wherein the mandrel (10; 110) is formed in line with the external face of the base (17; 217) with at least one sleeve (23; 24).
